(19) United States
(12) Patent Application Publication
(10) Pub. No.: US 2007/0288371 A1
(43) Pub. Date: Dec. 13, 2007

(54) PERSONAL ELECTRONIC PAYMENT SYSTEM AND RELATED METHOD

(76) Inventor: Aratha M. Johnson, Woodland Hills, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/753,124

(22) Filed: May 24, 2007

Related U.S. Application Data
(60) Provisional application No. 60/803,219, filed on May 25, 2006.

(51) Int. Cl. G06Q 40/00

(52) U.S. Cl. 705/41; 235/380

(57) ABSTRACT

A method for making person-to-person and person-to-retailer cash value exchanges in the form of electronic and card-based financial transactions is provided. A portable, hand-held electronic device is associated with a subscriber deposit account. The device is selectively activated by inputting a personal identification number, upon which a financial transaction in the form of receiving or making payments can be conducted. The hand-held device of the present invention can also be used to create temporary deposit accounts having a cash value assigned to blank payment cards having a pre-assigned identification code for later use as a debit card.

### BACKGROUND OF THE INVENTION

The present invention generally relates to electronic payment systems. More particularly, the present invention relates to a system and method for personal electronic payment, eliminating the need for individuals to carry cash or checks.

Credit cards and debit cards have been used for decades. Such cards typically have a sixteen-digit number (credit or debit card number), a four-digit expiration date number, and a cardholder's name and business affiliation, if any, embossed on the front side of the card. The logo of the credit association or bank, or both, is also printed on the front side. On its back side is a magnetic stripe wherein all the pertinent personal information of the cardholder, such as primary account number, name, expiration date and encrypted Personal Identification Number (PIN) are included. The information contained in the magnetic stripe is not visible or readable directly from the card, except with the use of special decoding equipment such as a magnetic stripe reader. More recently, credit and debit cards having such information on a chip, such as an RFID chip, have been used to store and convey such information. Also appearing on the back side of the card is a space for accommodating the cardholder's personal signature and more printed information about the credit card issuer and/or Automatic Teller Machine (ATM) locations.

Presently, such plastic cards are used for a variety of transactions, such as credit card purchases and automatic banking transactions. For example, when utilizing a credit or a debit card at a merchant to purchase goods or services, the credit card is “swiped” through a device which reads the information encoded on the magnetic stripe or electronic chip. This information is transmitted to a central computer, such as via a wired network, which determines whether the account number is valid and whether the purchase is within the amount of credit or account balance available for that account. If the transaction is authorized, the cardholder usually receives a paper receipt as his or her record of the transaction, and the retail merchant also keeps a copy of the receipt as a record of the transaction. Later, usually within thirty days, the card user receives a written statement, which, in the case of a credit card, contains an invoice for payment. The user must then write a check to the credit card company to pay the amount due on the account. Otherwise, late fees and interest accrue.

Such transactions have become very popular and widespread due to the convenience that it affords. The individual can purchase any good or service with a credit card, even if the individual does not have any checks or cash, or insufficient cash on his or her person. Moreover, if the individual loses his or her wallet, the cash is generally irretrievable. If checks are stolen or lost, the entire account must be closed. However, if a credit card is misplaced or stolen, the credit card can be inactivated with very little effort.

However, a disadvantage of such debit and credit cards is that they can only be used in association with merchants who accept such cards, requiring the merchant to have in place, the appropriate card reader devices, network system, etc. Many smaller merchants do not accept such debit or credit cards due to the increased cost of doing business.

Despite the proliferation of technological advances in the area of financial payments, the exchange of currency between individuals remains relatively unchanged. Inherent to the current alternatives for exchanging cash value, such as by cash, check, Automatic Clearing House (ACH) or Electronic Funds Transfer (EFT) transfers or Internet-based personal funds exchange services such as PayPal, are certain inconveniences related to time, security, and in some cases, access to technology.

The use of cash requires that an individual carry enough cash on his person at all times to satisfy all foreseen and unforeseen circumstances that may arise and require the exchange of money. When the individual does not have enough cash on hand, assuming that the other party to the transaction is willing/able to wait for payment, he must make a trip to the location where he can readily access cash, whether it be the nearest ATM, bank or mattress. The difficulties of a cash-based existence are obvious and age-old. The individual carrying cash is vulnerable to a host of risks for which there is little or no recourse such as robbery, loss or simple miscounting.

While checks provide some relief to the risks associated with cash transactions, they also pose other risks and inconveniences to both parties of the transaction. The individual writing the check must carry the cumbersome checkbook, making himself vulnerable to fraud that may result from the checkbook being lost or stolen. The individual receiving a check rarely has any means for verifying whether the check is good. Additionally, he must have access to an institution that will cash the check and may be subject to hefty check cashing fees or holds imposed by banks. Further, checks are not appropriate to all circumstances particularly in cases where the cash needs to be immediately available for spending as well as in situations where the payee is unable or unwilling to participate in the check cashing process (e.g., a minor, an individual without a bank account, etc.)

More recently, some banks have begun to permit ACH transfers between personal accounts. While the ability to make deposits directly into an account would appear to be the ideal solution, the current implementation falls short in terms of convenience, user-friendliness and ubiquity. Primarily, not all banks offer the service for personal accounts. Secondly, individuals must exchange sensitive personal banking information including the bank name, account number, routing number and in some cases recent deposit information. Additionally, transactions often are subject to minimum amounts, long approval times, significant fees, and may not occur immediately and are not always guaranteed to be completed.

Similarly, Internet-based personal funds exchange services such as PayPal address many of the issues posed above with three glaring exceptions. First, use of the services requires that parties have Internet access. Recent surveys suggest that nearly forty percent of U.S. households still do not have Internet access. Second, the transaction can only be consummated at a location where Internet access is available. Third, proceeds from the transaction are not immediately available for use.

Recently, there have been devised various forms of electronic wallet devices. Such devices are comprised of a processor, memory, keypad or the like, magnetic stripes and emulators with read/write capabilities. Many of these electronic wallet devices are primarily concerned with providing solutions for consolidating and storing an individual's personal and multiple credit card account information for use in traditional retail transactions. Examples of such devices and systems are disclosed in U.S. Pat. Nos. 4,868,376 to Lessin et al., 5,748,737 to Daggar, 5,955,961 to Wallerstien, and 6,925,439 to Pitroda. U.S. Pat. No. 6,089,451 to Krause discloses a device for capturing and converting credit card information which is capable of enabling and disabling in a selective manner the magnetic stripe for security purposes. However, such electronic wallet devices and systems are primarily geared for use in traditional retail transactions, and do not contemplate person-to-person transactions.

Accordingly, there is a continuing need for a person-to-person cash value exchange system which is secure, ubiquitously available, does not require the parties to disclose or exchange any personal financial information, offers immediate verification of execution, and offers immediate availability of funds upon completion. The present invention fulfills these needs, and provides other related advantages.

### SUMMARY OF THE INVENTION

The present invention resides in a personal payment system and related method. More particularly, the present invention resides in a method for making personal electronic and card-based financial transactions for realizing cash value exchanges from person-to-person. The system is secure, and does not require the parties to disclose or exchange any personal financial information. The system of the present invention offers immediate verification of execution, and offers immediate availability of funds upon completion.

The method generally comprises the steps of opening and maintaining a subscriber deposit account having a cash balance. A portable, hand-held electronic device is provided. The device has a memory including a unique identification code associated with the subscriber deposit account. The hand-held electronic device also includes an input, such as a keypad, and means for reading a financial card. The device typically includes a display, as well as a wireless communication module for sending and receiving data. A processor is used to encrypt the data. The hand-held device may also include means, such as GPS, for tracking the location of the device. Typically, an individual will subscribe to a service which provides the hand-held device and maintains the subscriber deposit account.

The hand-held device is activated by inputting a personal identification number or code. A financial transaction is requested by sending an encrypted wireless electronic message using the hand-held device. This message includes the debit or credit transaction type, the transaction amount, and account identification data. A second hand-held device owned by another individual, or a merchant point-of-sale device, sends an electronic message requesting a corresponding debit or a credit transaction type, transaction amount, and account identification data. The validity of the financial debit and credit transaction request is verified. This includes authenticating the incoming electronic messages and verifying the availability of sufficient funds to cover the requested transaction. The incoming messages are also matched to ensure the transaction type and transaction amount are in agreement. When making a payment financial transaction using the hand-held device, funds are debited from the user's subscriber deposit account. However, when the user is receiving payment, the funds are credited to the subscriber deposit account. A confirmation message is sent to the hand-held device after approval of the financial transaction.

In one embodiment of the present invention, blank payment cards are provided to facilitate transactions with non-subscribers. Each card has a pre-assigned identification code. However, the blank payment cards are not yet associated with an account having a credit or cash balance and have no inherent value. The hand-held device is used to read the identification code of the blank payment card. A cash amount to be associated with the blank payment card is designated using the hand-held device. An electronic message is sent using the hand-held device which includes the cash amount to be associated with the blank payment card, and the identification code of the blank payment card. A temporary account funded by the subscriber deposit account is created in the amount of the cash amount associated with the blank payment card. The account has an identification code which is associated with the identification code of the blank payment card so as to be reserved solely for that card. The confirmation message is sent to the hand-held device after approval of the financial transaction. The blank payment card can be used to make payments to hand-held devices used in accordance with the present invention, or as a debit card in existing financial networks, such as ATMs or merchant point-of-sale devices.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an elevational view of a portable, hand-held electronic device used in accordance with the present invention, having a financial transaction card being swiped through a reader thereof;

FIG. 2 is a side elevational view of the device of FIG. 1;

FIG. 3 is a front elevational view of another hand-held electronic device used in association with the present invention, and illustrating an electronic financial transaction card being swiped through a reader thereof, in accordance with the present invention;

FIG. 4 is a side elevational view of the device of FIG. 3;

FIG. 5 is a diagrammatic view illustrating the system elements, and their interconnectivity via networks;

FIG. 6 is a flowchart depicting the steps taken in accordance with the present invention when a user makes or receives payment; and

FIG. 7 is a flowchart depicting the steps taken in association with custom funding of blank payment cards, in accordance with the present invention.

### DETAILED DESCRIPTION OF THE PREFERRED EMBODIMENTS

The present invention resides in a personal electronic payment system which is designed to enable electronic and card-based financial transactions between consumers, and more particularly, merchant-to-individual transactions as well as individual-to-individual transactions. As will be more fully described herein, the system combines hand-held equipment, software, databases, wireless communications and transaction processing technologies to allow individuals to transfer cash value without the use of cash or personal checks.

In accordance with the present invention, a subscriber deposit account is opened and maintained. Typically, individuals using the present invention are subscribers to the system, which open and maintain the subscriber deposit account, and which purchase or otherwise receive portable, hand-held devices, as will be more fully described herein. The cash value attributed to the subscriber is stored in the subscriber deposit account. As will be more fully described herein, all funds for system-enabled payments made by the subscriber are debited from the subscriber deposit account. Conversely, all funds received by the subscriber via the system-enabled transactions are credited to the subscriber deposit account. The subscriber deposit account includes an identification code or account number. The subscriber is given a security code or personal identification number or the like for accessing the subscriber deposit account. The subscriber, as needed or wanted, may debit or credit cash value to the account. For example, the account may be accessible through a network, such as the Internet, and the subscriber may fund the subscriber deposit account on an ongoing basis in order to maintain it.

The system of the present invention is typically a subscription-based service comprised of the subscription deposit account, a hand-held device, custom funded electronic payment or debit cards, and a transaction processing platform which includes a data transfer network and protocol.

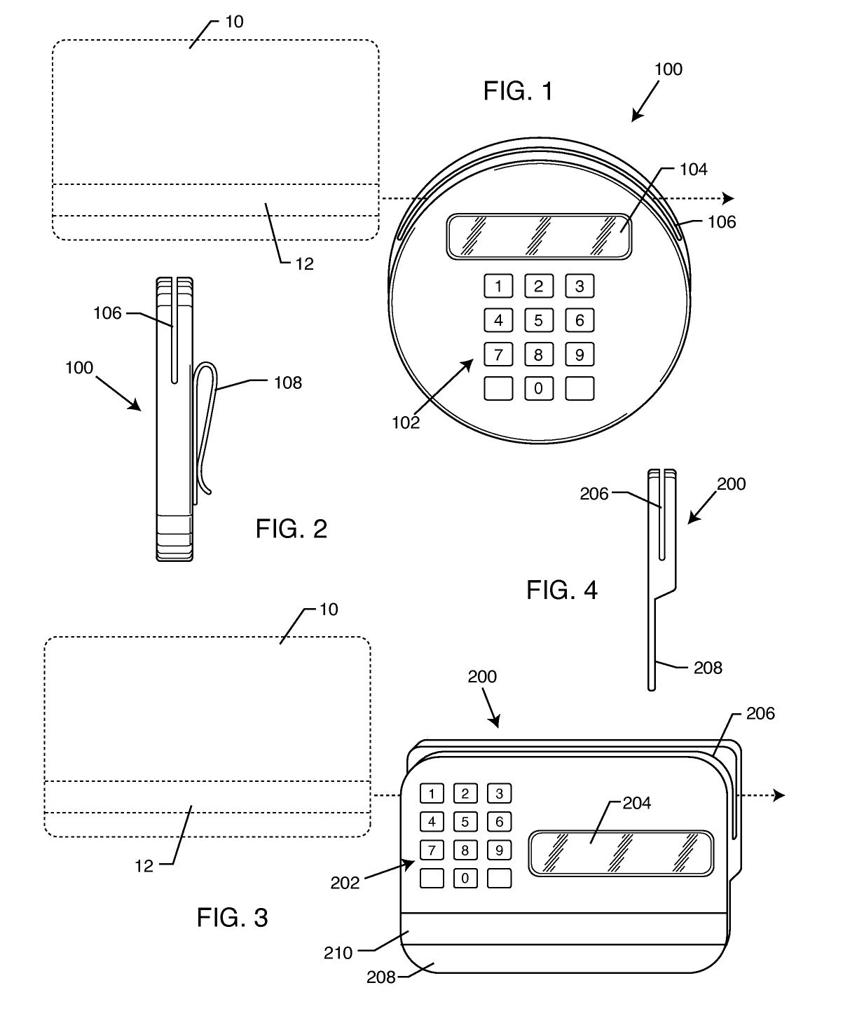

With reference now to FIGS. 1 and 2, a portable, hand-held device 100 used in accordance with the present invention is illustrated. As can be seen in FIG. 1, the hand-held device is approximately the size of a standard credit or debit card 10 or the like. More importantly, the device 100 is sized so as to be hand-held and portable, such as being placed in one's pocket, purse or the like so as to be easily accessible and carried on one's person. For example, it is contemplated that the device 100 could approximate the size of a cellular phone or the like. The device 100 includes a processor or programmable logic which provides management and temporary storage of data input/output as well as data encryption. The device 100 also includes a wireless communication chip for wireless data transfer of transaction details over a network to a transaction processing platform, as will be described more fully herein. The device 100 is typically battery powered.

The device 100 further comprises a keypad 102, or other data entry means, enabling the user to input information, such as a personal identification number, a transaction amount, a send/accept response, or to cancel a transaction. Typically, the keypad 102 includes the digits 0-9, as well as additional buttons which may be used for insertion of a decimal point, sending a transaction, receiving a payment transaction, or canceling a transaction. A display 104, such as an LCD display, shows data as entered by the user and also displays system messages received by the device 100. The device 100 also includes a reader 106 which allows subscribers or users to receive payments. The card reader 106 captures account information necessary to execute transactions from credit cards, debit/ATM cards 10 or the like. Such financial transaction cards 10 are illustrated having a magnetic stripe 12, as is commonly used presently. However, it will be appreciated that the financial transaction card 10 could comprise what is known as a smart card, incorporating an integrated circuit or the like, such that the reader 106 includes the necessary contacts and sensors for reading a contact integrated circuit, or even a contactless card 10. Thus the reader 106 is capable of reading and capturing account information from the card 10 necessary to execute the transaction. As will be more fully described herein, the device 100 can also read and capture account information from another subscriber's hand-held device incorporating an account identification output means, such as a magnetic stripe, RFID chip, integrated circuit check, or the like.

FIG. 2 illustrates the slot comprising the reader 106 for swiping the magnetic stripe 12 of a financial transaction card 10, or even smart cards having contact integrated circuit chips or the like thereon. Of course, the reader 106 could comprise a contactless reader wherein an RFID chip or the like brought into close enough proximity to the reader 106 would convey the financial transaction cards 10 account information necessary to execute the transaction. FIG. 2 also illustrates a belt clip 108, such that the device 100 can be attached to an individual's belt, pants, shirt pocket, or the like. It will also be appreciated that other means for attaching the device 100 to a keychain or the like could be fixed to the housing of the device 100. Of course, such attachment means are not necessary, but merely provide a convenience to the user.

With reference now to FIGS. 3 and 4, another portable, hand-held device 200 embodying the present invention is illustrated. This device 200 is similar in size and function as the device 100 described above. For instance, the device 200 includes a keypad 202, or other data entry means, for entering a personal identification code or number, entering in the amount of the transaction, executing functions, such as sending or receiving information or canceling the transaction, etc. A display 204, such as an LCD display shows data as entered by the user, as well as displays system messages. A reader 206 is incorporated into the device 200, and has similar characteristics and functions as the reader 106 described above with respect to the device 100 in that the reader 206 can read and capture account information from a financial transaction card 10, whether it be by magnetic stripe 12, contact smart cards, contactless smart cards, or the like.

The device 200 illustrated in FIGS. 3 and 4 is different in the sense that in addition to receiving payments, the device 200 also enables the user to make electronic payments. As such, the device 206 includes a relatively thin extension 208 having a magnetic stripe 210 thereon encoded with the user's account information. Of course, it will be appreciated by those skilled in the art that the magnetic stripe 210 could be replaced with contact integrated circuit chips or other electronic data transfer means. It will also be appreciated by those skilled in the art that the device 200 could incorporate wireless or contactless technology such that the device 200 merely would be brought into close proximity to a reader. In any event, the account information output contains the subscriber account identifying information necessary to execute purchase or debit transactions.

The hand-held devices 100 and 200 of the present invention do not in and of themselves store any cash value. Instead, they are used as a link in accessing the user's deposit account. Preferably, the devices 100 and 200 only act as a temporary storage of data received from a third party's financial transaction card 10 or hand-held device 200. For security purposes, once the transaction is completed, this information may be deleted or an overwrite function may effectively delete the information upon the next transaction. Notwithstanding this, the devices 100 and 200 in and of themselves represent an investment, and potentially could provide access to the subscriber or user's deposit account. Thus, the present invention contemplates that the device 100 or 200 could be deactivated, such as when stolen, lost, etc. Such deactivation could occur in a wireless manner. Alternatively, the user's deposit account could be given a new account number, or only accessed through a new personal identification number or code provided with a replacement hand-held device 100 or 200. It is also contemplated that the hand-held device 100 or 200 could include tracking means, such as a GPS chip which would allow the service provider to track and lock the devices if lost or stolen.

The hand-held devices 100 and 200 are the primary vehicles for the transaction of the present invention. Each subscriber to the system of the present invention receives either the reader only device of version 100, or the reader and payment device 200, which uniquely identifies the subscriber and the deposit account. As described above, the device 200 combines account identification storage 210 (which may be implemented via magnetic stripe or other generally accepted technologies) with a card reader 206 in one unit 200 to allow subscribers to make and receive payments.

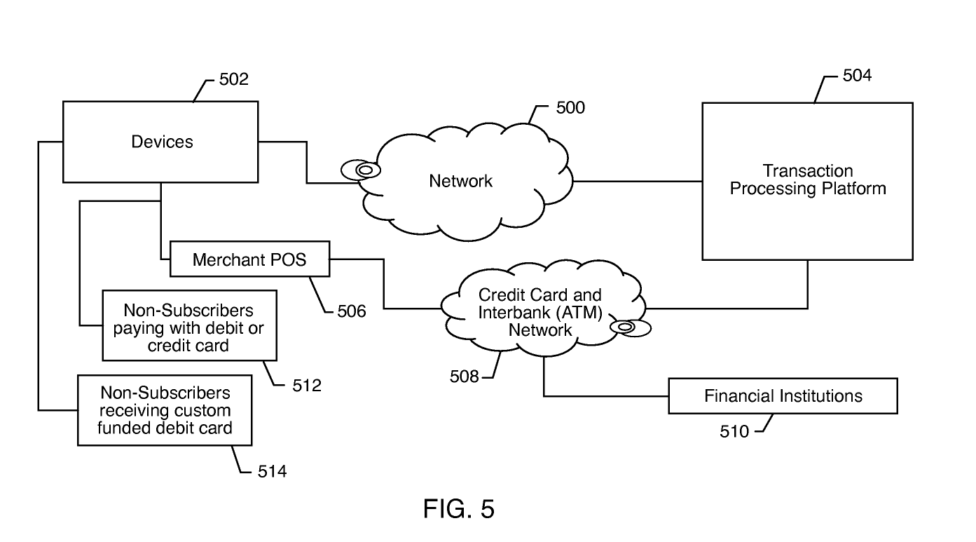

With reference now to FIG. 5, a diagram is provided illustrating the interaction between the hand-held devices 100 and 200 of the present invention with a network and transaction processing platform of the present invention, financial institutions, merchant point-of-sale equipment, and ATM and credit card interbank networks. This represents what is referred to herein as the data transfer network and protocol. The transfer of data necessary to execute all transactions occurs over the system data transfer network according to a defined set of rules designed to insure accuracy and security. More specifically, the network (500) will transfer data in the form of messages between the devices 100 and 200 (502) and the system transaction processing platform (504).

The network design may be based on the TCP/IP four or five layer reference model, or other models as developed and accepted for use according to regulatory and business partner requirements. The network typically employs a combination of wireless and land-based segments as determined by regulatory and business partner requirements, including but not limited to, wireless communications service providers, interbank and credit card network providers and regulators.

With continuing reference to FIG. 5, currently, merchant point-of-sale equipment (506) is connected in a wired manner to credit card and interbank (ATM) networks (508) for providing access to the account information within the financial institution (510). For example, if the financial transaction card is a debit card, the merchant point-of-sale equipment 506 will capture the account identification information and through the card's network (508) communicate with the financial institution (510) to determine that there is an adequate cash balance to approve the transaction. This is the traditional methodology used for non-subscribers paying with debit or credit cards (512). However, as described above, the hand-held device 200 may include means for making payments, even through the merchant point-of-sale equipment (506). Moreover, the hand-held devices may read the non-subscriber's credit or debit card (512) and process the payment accordingly. Lastly, as will be more fully described herein, the present invention enables the creation of custom funded debit cards (514), which may be activated using the hand-held devices. Such custom funded debit cards can be redeemed through the hand-held devices of the present invention, or through merchant point-of-sale equipment.

The system's transaction processing platform is designed to maintain the stasis of the database(s) of the deposit accounts, by insuring that any actions carried out in the course of a transaction on the database is either completed successfully or canceled successfully. The hardware, software and methodology implemented may vary according to industry standards, liability and regulatory acceptance. The hand-held devices 100 or 200 or the merchant point-of-sale equipment or financial institutions send a message to the transaction processing platform of the present invention requesting the initiation of a transaction. The request message includes account identification, security information, transaction type and transaction amount. The transaction processing platform of the present invention verifies the authenticity of each incoming request and matches those requests based upon the data provided in the request message. Upon confirming the validity and matching of requests for debit and credit, the transaction processing platform records the appropriate debits and credits. Finally, the transaction processing platform returns confirmation messages to the devices participating in the transaction prior to terminating the transaction.

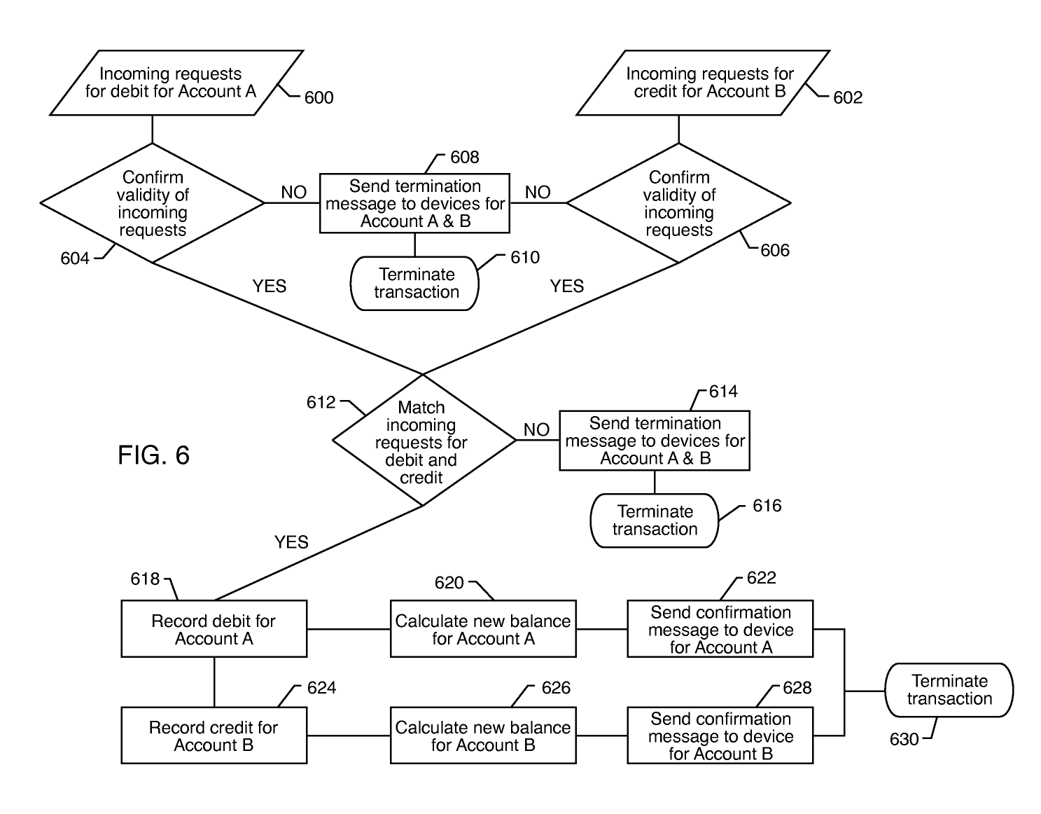

With reference now to FIG. 6, the steps taken in accordance with the transaction processing platform are illustrated. The system receives an incoming request for debit for “Account A” (600). “Account A” may represent a subscriber or user of the present invention who intends to transfer cash value to another user or subscriber of the present invention, a custom funded debit card, or a merchant. Alternatively, “Account A” may represent a holder of a custom funded debit card created by the system who intends to transfer cash value to either a subscriber of the invention or a merchant. In yet another alternative, “Account A” may represent a debit/credit card holder who intends to transfer cash value to a user or subscriber of the present invention.

Nearly simultaneously, the transaction processing platform receives an incoming request for credit for “Account B” (602). “Account B” represents a deposit account subscriber or user of the present invention who intends to receive cash value from either a third party subscriber or user of the present invention, a holder of a custom funded debit card created in accordance with the present invention, or a debit/credit card holder in the traditional sense. “Account B” may also represent a custom funded debit card being activated by a subscriber or user of the present invention. “Account B” may also represent a merchant who intends to receive cash value from a subscriber or user having the necessary device 200, or a holder of a custom funded debit card created in accordance with the present invention.

The system first confirms the validity of the incoming request for debit for “Account A”. The validity of the incoming request for credit for “Account B” is also confirmed (606). Confirmation includes verifying the authenticity or validity of each incoming request, such as by verifying the user identification code, checking that the device generating the incoming request has not been reported lost or stolen, etc. The system matches the account identification in each of the electronic messages with the account identification of the account from which funds are to be debited or credited, and confirms the validity thereof. A termination message is sent to the devices for “Accounts A and B” (608) if the validity of either of the incoming requests cannot be confirmed. The transaction is then terminated (610).

However, if the incoming requests are confirmed valid, the system then matches the incoming requests for debit and credit (612), that is, the transaction amount must correspond between the incoming request for credit and the incoming request for debit. If not, a termination message is sent to the devices for “Accounts A and B” (614), and the transaction is terminated (616). However, if the incoming request for debit and credit, and transaction amount, is matched and confirmed, the system records a debit for “Account A” (618), calculates a new balance for “Account A” (620), and sends a confirmation message to the device for “Account A” (622). This is done in real time, typically in a wireless manner. Nearly simultaneously, in real time, the system records a credit for “Account B” (624), calculates a new balance for “Account B” (626), and sends a confirmation message to the device for “Account B” (628). The transaction is then terminated (630).

It will be appreciated by those skilled in the art that when the hand-held devices 100 or 200 are used, the incoming requests for debit or credit for either “Account A or B” is done in a wireless manner in real time. Within a short time, typically only seconds, the transaction is either terminated for validity reasons, or the debit/credit is recorded and confirmed. That is, the system of the present invention preferably sends a wireless confirming message to the hand-held device 100 or 200 (or a message indicating failure of the transaction. Typically, for security purposes, the outgoing message from the hand-held device 100 or 200 is encrypted, and the incoming wireless message from the transaction processing platform may also be encrypted. The hand-held device 100 or 200, as described above, is a processor for encrypting and/or decrypting the transmitted data.

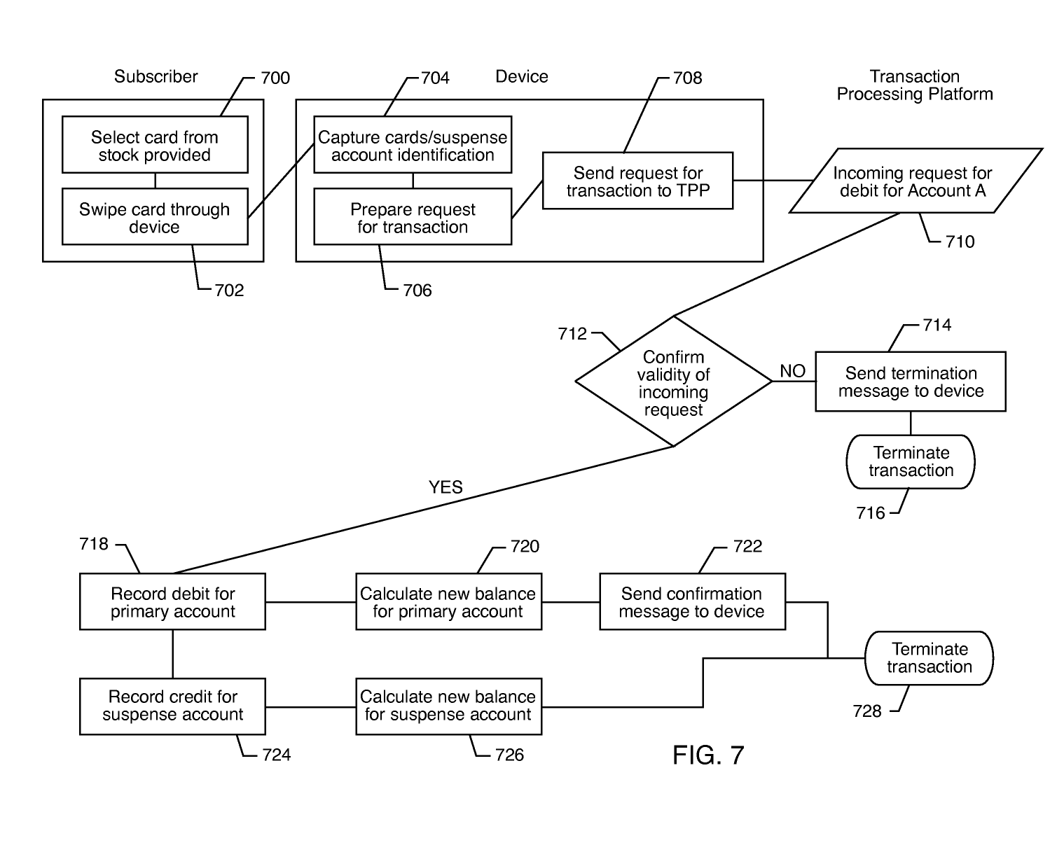

With reference now to FIG. 7, the present invention provides a method for creating blank payment cards, similar to debit cards, which originally are provided to the subscriber or user of the system, have a pre-assigned identification code or number, but are not “activated”, that is they are not associated with any credit or cash balance. This allows subscribers or users of the present invention to fund and activate prepaid debit cards/blank payment cards as an alternative payment vehicle for use when making payments to individuals who are not subscribers or users of the present invention. Each user of the present invention purchases or otherwise obtains a supply of inactive debit or blank payment cards which are linked to the user's deposit account.

In order to use the cards as payment, the subscriber or user of the system of the present invention must activate the card by assigning a cash value to the card. This may be done, for example, via telephone or the Internet, wherein the user enters the unique identification code or number for the inactive card and assigns a cash value to it. When this occurs, the corresponding cash value within the deposit account is either reserved for transactions relating to the card, or more typically, a suspense account is created having an account identification number or the like which is directly linked to the identification number of the activated card. That is, the cash value assigned to the card is debited from the deposit account and held in a suspense account linked to the deposit account for use by a recipient of the card. The card can be used to make retail purchases through merchant point-of-sale equipment, or ATM withdrawals or the like.

With continuing reference to FIG. 7, such custom funded debit or blank payment cards can be activated using the hand-held device 100 or 200 of the present invention. This is done by a user selecting a card from the stock provided (700), and swiping, or otherwise reading, the card through the hand-held device (702). The hand-held device 100 or 200 captures the card's account identification (704), and prepares a request for a transaction (706). The request for transaction (which is typically encrypted and created as a wireless data message) is sent for execution to the system transaction processing platform (708). The Transaction Processing Platform (TPP) receives the incoming request for debit for “Account A”, that is, the subscriber deposit account (710). The validity of the incoming request is first confirmed (712). If it is not, a termination message is sent to the device (714) and the transaction is terminated (716). This can occur, for example, if the subscriber deposit account (“Account A”) does not have sufficient funds to meet the request. This may also occur, for example, if the debit or blank payment card account identification is not confirmed.

However, if the validity of the incoming request is confirmed, the system records a debit for the primary account, or “Account A” (718), and then the balance is calculated for the account (720) and a confirmation message sent to the hand-held device (722). A suspense account is created, or if already existing is credited the transaction amount (724), and a new balance for the suspense account is calculated (726), before the transaction is terminated (728).

Once the debit or blank payment card is activated, by creating or funding a suspense account as described above, the holder of the custom funded debit card can use the card as if it were a debit card, or a card having a given cash value. The card can be used for making payments at merchants having POS equipment and systems, through accepting ATMs, or by making person-to-person payments to users or subscribers of the present invention by swiping the card through a reader of the user's hand-held device 100 or 200. While this feature is primarily directed to non-subscribers or users of the present invention, it will also be appreciated that a user or subscriber of the present invention may activate and fund his or her own custom funded cards. For example, if the subscriber owns a hand-held device 100 which only includes a reader, in order to make card transactions, the user can custom fund his or her own blank payment cards/debit cards for use with other subscribers or users of the present invention, or merchant POS or even ATMs.

The following examples will illustrate how the invention can be used. In a first scenario, John wishes to pay Jane twenty dollars. Both John and Jane own hand-held devices and have funded deposit accounts. John unlocks and activates his hand-held device 200, such as by entering in his PIN. John enters “20.00” on his keypad and presses the “pay” or “send” button, causing the device 200 to send a message to the transaction processing platform. The message notifies the system that John has authorized a payment of twenty dollars from his account, and that a request for payment will arrive shortly.

Jane unlocks and activates her hand-held device 100 or 200, such as by entering her PIN. Jane enters “20.00” on her keypad and presses the “receive” button, causing the device 100 or 200 to store the dollar amount which will be added to John's account information in the next step. At this time, no message is sent. John then swipes the card side 208 and 210 of his device 200 into Jane's reader 106 or 206, which collects John's account information. The device sends a message containing John's account information and the transaction amount to the system transaction processing platform. This may occur automatically, or Jane may be required to press a button, such as “send” or the “receive” button again. The message requests a debit of twenty dollars from John's account and the credit of twenty dollars to Jane's account.

The system receives and matches the messages. If the account information and dollar amounts in the messages from John and Jane match, a confirmation is sent to both devices and the transaction is completed.

In another scenario, Jane, who owns a hand-held device 100 or 200 and has a funded deposit account, desires to pay Jack thirty dollars, but Jack does not have a hand-held device. Jane unlocks and activates her device, such as by entering her PIN. Jane enters “30.00” on her keypad and presses the “pay” button, causing the device to send a message to the transaction processing platform authorizing a payment of thirty dollars from her account, and that the request for payment will arrive shortly. Jane then swipes a blank or inactive “prepaid debit card”, also referred to herein as a custom funded blank payment card in her reader. The reader collects the card's identification information. Jane presses the “pay” button again, alerting the system that Jane is about to issue a prepaid card. The hand-held device 100 or 200 sends a message containing the prepaid card information and the transaction amount to the transaction processing platform. The messages effectively requests that thirty dollars be set aside from Jane's account and be made available for any payment Jack makes with the prepaid card. The system receives the message and sends confirmation to Jane's hand-held device. Any subsequent payment made using Jack's prepaid card will be debited against the amount set aside in Jane's account for Jack's card.

In yet another scenario, Sally wishes to pay John forty dollars. John owns a hand-held device 100 or 200 and has a funded deposit account, but Sally does not. John unlocks and activates his device 100 or 200, such as by entering his PIN. John enters “40.00” on his keypad and presses the “receive” button, causing the device to store the dollar amount which will be added to Sally's ATM card information in the next step. Sally then swipes her ATM card (which could also comprise any other existing financial transaction card) in John's reader 106 or 206. Sally may be required to enter her PIN, such as if the card is an ATM card. The reader collects Sally's bank account information and authorization. A message is sent from the device containing Sally's bank information, authorization and the transaction amount to the system's transaction processing platform. The message requests that the system secure payment from Sally's bank or financial institution. Before the message is sent, John may be required to press a button, such as the “receive” button again. The system receives the message and completes the transaction with Sally's bank, and sends a confirmation message to John's hand-held device 100 or 200.

In yet another scenario, Jane buys groceries or other goods or services from a merchant. Jane owns a hand-held device 200 and has a sufficiently-funded deposit account. The merchant uses standard POS equipment. The cashier totals Jane's purchase and Jane swipes the card side 208 of her device 200 in the store's POS terminal and follows the instructions for an ATM card purchase. The store's POS equipment will communicate with the system of the present invention the same way it carries out ATM transactions. The system receives the message and completes the transaction.

It will be appreciated by those skilled in the art that the payment system elements described above operate in concert to provide a convenient, secure and reliable vehicle for electronic transfer of cash value between individuals. It also allows for that cash value to be used to make retail purchases. The present invention does not require that the parties disclose or exchange any personal financial information, other than that collected and transferred via the financial transaction card or hand-held device. It offers immediate verification of execution and the availability of the funds are available immediately upon the completion of the financial transaction such that it is performed on real time. The present invention further enables individuals to make cash value transactions between one another without the use of cash or checks.

Although several embodiments have been described in some detail for purposes of illustration, various modifications may be made without departing from the scope and spirit of the invention. Accordingly, the invention is not to be limited, except as by the appended claims.

What is claimed is:

1. A method for making personal electronic and card-based financial transactions, comprising the steps of:
opening and maintaining a subscriber deposit account having a cash balance;
providing a portable, hand-held electronic device associated with the subscriber deposit account, and having an input, means for reading a financial card, a display and a wireless communication module for sending and receiving data;
activating the hand-held device by inputting a personal identification number;
requesting a financial transaction by sending a wireless electronic message;
debiting funds from the subscriber deposit account when making a payment financial transaction using the hand-held device, or crediting funds to the subscriber deposit account when receiving electronic payments using the hand-held device; and
sending a confirmation message to the hand-held device after approval of the financial transaction.

2. The method of claim 1, wherein the providing step includes the step of providing a hand-held device having a memory including a unique identification code associated with the subscriber deposit account, an input keypad, and a processor for encrypting transmitted data.

3. The method of claim 1, wherein the providing step includes the step of providing a hand-held device having means for tracking the location of the device.

4. The method of claim 1, including the step of subscribing to a service which provides the hand-held device and maintains the subscriber deposit account.

5. The method of claim 1, wherein the requesting financial transaction step includes the step of sending an electronic message including transaction type, transaction amount, and account identification.

6. The method of claim 5, including the step of encrypting the electronic message.

7. The method of claim 5, including the step of verifying the validity of the financial transaction request including matching the account identification in the electronic message with the account identification of the account from which funds are to be debited or credited.

8. The method of claim 6, wherein the verifying step further includes the steps of matching the transaction type and the transaction amount.

9. The method of claim 1, wherein the requesting a financial transaction step includes the step of the hand-held device sending an electronic message requesting a debit or a credit, and a second hand-held device or a merchant point-of-sale device sending an electronic message requesting a corresponding debit or a credit.

10. The method of claim 9, including the steps of matching the debit and credit message requests.

11. The method of claim 1, including the step of providing a blank payment card having an assigned identification code but without any credit or cash balance associated therewith.

12. The method of claim 11, including the steps of:
reading the identification code of the blank payment card using the hand-held device;
designating a cash amount to be associated with the blank payment card;
sending an electronic message using the hand-held device, including the cash amount to be associated with the blank payment card and the identification code of the blank payment card; and
creating a temporary account funded by the subscriber deposit account in the amount of the cash amount associated with the blank payment card and having an identification code associated with the identification code of the blank payment card.

13. A method for making personal electronic and card-based financial transactions, comprising the steps of:
opening and maintaining a subscriber deposit account having a cash balance;
providing a portable, hand-held electronic device having a memory including a unique identification code associated with the subscriber deposit account, an input keypad, a means for reading a financial card, a display and a wireless communication module for sending and receiving data, and a processor for encrypting transmitted data;
activating the hand-held device by inputting a personal identification number;
requesting a financial transaction by sending an encrypted wireless electronic message using the hand-held device, including debit or credit transaction type, transaction amount, and account identification data;
a second hand-held device or a merchant point-of-sale device sending an electronic message requesting a corresponding debit or a credit transaction type, transaction amount, and account identification data;
verifying the validity of the financial debit and credit transaction requests including matching the account identification in the electronic messages with the account identification of the account from which funds are to be debited or credited, and matching the transaction type and the transaction amount;
debiting funds from the subscriber deposit account when making a payment financial transaction using the hand-held device, or crediting funds to the subscriber deposit account when receiving electronic payments using the hand-held device; and
sending a confirmation message to the hand-held device after approval of the financial transaction.

14. The method of claim 13, wherein the providing step includes the step of providing a hand-held device having means for tracking the location of the device.

15. The method of claim 13, including the step of subscribing to a service which provides the hand-held device and maintains the subscriber deposit account.

16. A method for making personal electronic and card-based financial transactions, comprising the steps of:
opening and maintaining a subscriber deposit account having a cash balance;
providing a portable, hand-held electronic device having a memory including a unique identification code associated with the subscriber deposit account, an input keypad, a means for reading a financial card, a display and a wireless communication module for sending and receiving data, and a processor for encrypting transmitted data;
activating the hand-held device by inputting a personal identification number;
providing a blank payment card having an assigned identification code but not associated with an account having a credit or cash balance;
reading the identification code of the blank payment card using the hand-held device;
designating a cash amount to be associated with the blank payment card;
sending an electronic message using the hand-held device, including the cash amount to be associated with the blank payment card and the identification code of the blank payment card; and
creating an account funded by the subscriber deposit account in the amount of the cash amount associated with the blank payment card and having an identification code associated with the identification code of the blank payment card; and
sending a confirmation message to the hand-held device after approval of the financial transaction.

17. The method of claim 16, wherein the providing step includes the step of providing a hand-held device having means for tracking the location of the device.

18. The method of claim 16, including the step of subscribing to a service which provides the hand-held device and maintains the subscriber deposit account.
